(19) United States
(12) Patent Application Publication
(10) Pub. No.: US 2015/0006636 A1
(43) Pub. Date: Jan. 1, 2015

(54) METHOD AND APPARATUS FOR OPERATING DIRECTORY

(71) Applicant: Samsung Electronics Co., Ltd., Suwon-si (KR)

(72) Inventors: Chulhyung YANG, Gumi-si (KR); Jinwan AN, Daegu (KR); Yonggil HAN, Gumi-si (KR)

(21) Appl. No.: 14/315,859

(22) Filed: Jun. 26, 2014

(30) Foreign Application Priority Data
Jun. 28, 2013 (KR) 10-2013-0075833

(51) Int. Cl. H04L 29/08; G06F 17/30

(52) U.S. Cl. CPC H04L 67/10; G06F 17/30424
USPC 709/204

(57) ABSTRACT

A method for operating a directory is provided. The method includes detecting a directory related to a specific application or an app when a connection for data communication with a specific electronic device is detected and transmitting the detected directory or information about the detected directory to a second electronic device and an apparatus supporting the method.

### CROSS-REFERENCE TO RELATED APPLICATION(S)

This application claims the benefit under 35 U.S.C. §119(a) of a Korean patent application filed on Jun. 28, 2013 in the Korean Intellectual Property Office and assigned Serial number 10-2013-0075833, the entire disclosure of which is hereby incorporated by reference.

### TECHNICAL FIELD

The present disclosure relates to an electronic device. More particularly, the present disclosure relates to a method and an apparatus for operating a directory, which are capable of more intuitively detecting and displaying a directory of a specific electronic device when electronic devices are connected.

### BACKGROUND

A user can connect a Personal Computer (PC) and a portable terminal, for example, through a Universal Serial Bus (USB). When the PC is connected to the portable terminal, a PC explorer may operate by default. When the PC explorer operates in conjunction with the portable terminal, the highest folder (e.g., a storage, a Secure Digital (SD) card, and the like) regarding portable terminal information is output. In this case, a user has to inconveniently move to a desired file in multiple stages through the PC explorer.

Therefore, a need exists for a method and an apparatus for operating a directory, wherein a specific directory can be searched for more rapidly and a request to transmit at least one file included in a directory or a directory to another electronic device can be made more conveniently.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus for operating a directory, wherein a specific directory can be searched for more rapidly and a request to transmit at least one file included in a directory or a directory to another electronic device can be made more conveniently.

In accordance with an aspect of the present disclosure, a method for operating a directory is provided. The method includes detecting a directory related to a specific application or an app when a connection for data communication with a specific electronic device is detected and transmitting the detected directory or information about the detected directory to a second electronic device.

In accordance with another aspect of the present disclosure, an electronic device is provided. The electronic device includes a communication unit configured to perform a connection for data communication with a specific electronic device and a control unit configured to detect a directory related to a specific app when the connection for data communication with the specific electronic device is detected and to control an operation for transmitting the detected directory or directory indication information to the specific electronic device.

In accordance with another aspect of the present disclosure, a method for operating a directory is provided. The method includes detecting a connection for data communication with a specific electronic device, receiving a directory regarding a specific app or information about the directory from the specific electronic device, and displaying the received directory regarding the specific app or the received information about the directory.

In accordance with another aspect of the present disclosure, an electronic device is provided. The electronic device includes a communication unit configured to perform a connection for data communication with a specific electronic device and to receive a directory related to a specific app or information about the directory from the specific electronic device, a display unit configured to display the received directory or the received information, and a control unit configured to control the reception and control of the information.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a fragmental construction of a first electronic device according to an embodiment of the present disclosure;

FIG. 2 is a flowchart illustrating a detection of a directory for execution of an application or an app when a first electronic device and a second electronic device are connected according to an embodiment of the present disclosure;

FIGS. 3A, 3B, and 3C illustrate a detection of a directory for execution of an app when a first electronic device and a second electronic device are connected according to an embodiment of the present disclosure;

FIG. 4 is a flowchart illustrating a detection of a directory according to a connection between a second electronic device and a first electronic device while the first electronic device executes an app according to an embodiment of the present disclosure;

FIGS. 5A and 5B illustrate a detection of a directory according to execution of an app when a second electronic device is connected to a first electronic device while the first electronic device executes an app according to an embodiment of the present disclosure;

FIG. 6 is a flow diagram illustrating data communication between a first electronic device and a second electronic device according to an embodiment of the present disclosure;

FIG. 7 illustrates a flow of signals for data communication between a first electronic device and a second electronic device according to an embodiment of the present disclosure; and

FIG. 8 is a flowchart illustrating data communication with a second electronic device according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The various embodiments disclosed in the present disclosure and drawings are illustrated to present specific examples in order to clarify the technical contents of the present disclosure and help in understanding of the present disclosure, but are not intended to limit the scope of the present disclosure. It will be evident to those skilled in the art that various implementations based on the technical spirit of the present disclosure are possible in addition to the disclosed various embodiments.

According to various embodiments of the present disclosure, when electronic devices for data communication are connected, a directory detection device may be a smart phone, a tablet Personal Computer (PC), a Personal Digital Assistant (PDA), and the like.

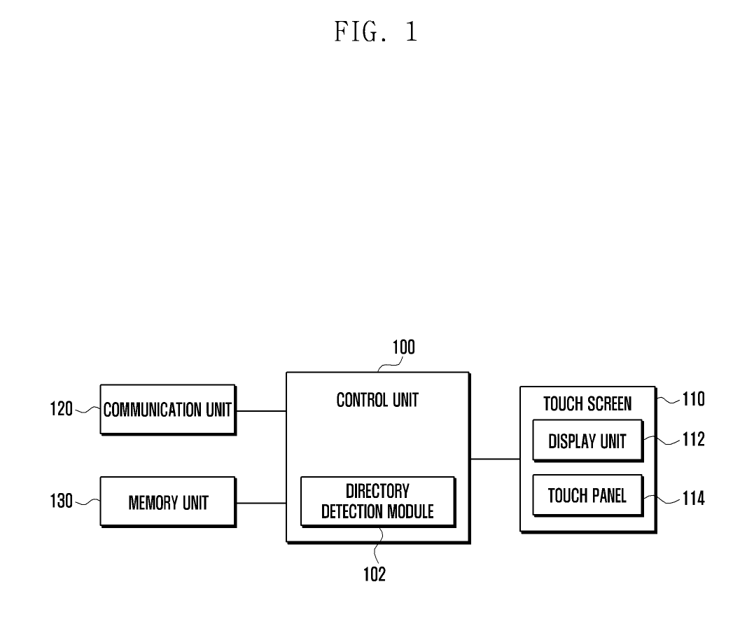

FIG. 1 is a block diagram illustrating a fragmental construction of a first electronic device according to an embodiment of the present disclosure.

The construction of the first electronic device may be similarly applied to a second electronic device. The present disclosure discloses a technique for transmitting directory information or a directory related to an application or an app, being executed in the first electronic device, to the second electronic device when the first electronic device and the second electronic device are connected. Accordingly, the first electronic device may be one of various types of electronic devices, such as a portable terminal, a PC device, a pad, a slate PC, and a note PC, and the second electronic device may be one of various types of electronic devices, such as a portable terminal, a PC device, and a pad. In the following description, the first electronic device is illustrated as being a portable electronic device and the second electronic device is illustrated as being a PC device, but the present disclosure is not limited thereto. As described above, each of the first electronic device and the second electronic device may be any one of various electronic devices.

Referring to FIG. 1, the first electronic device of the present disclosure may include elements, such as a touch screen 110, a display unit 112, a touch panel 114, a communication unit 120, a memory unit 130, a control unit 100, a directory detection module 102, and the like.

The first electronic device of the present disclosure may be implemented to have elements fewer or greater than the elements shown in FIG. 1. For example, the first electronic device may be configured to further include various sensors (e.g., an infrared sensor, an illuminance sensor, an image sensor, a proximity sensor, and the like) for detecting a user's various gestures, a Wireless Local Area Network (WLAN) module for supporting the wireless Internet, a short-distance communication module for supporting various short-distance communication techniques (e.g., Bluetooth, Bluetooth Low Energy (BLE), and Near Field Communication (NFC)), and a broadcasting reception module for receiving broadcasting signals from an external broadcasting management server through broadcasting channels (e.g., satellite broadcasting channels and terrestrial broadcasting channel).

The touch screen 110 may be configured to include the display unit 112 and the touch panel 114.

The display unit 112 can display various images according to the use of the first electronic device under the control of the control unit 100. The various images may include, for example, a lock screen, a home screen, an app list screen, an app execution screen, and a text entry screen. Here, when the control unit 100 processes (e.g., decodes) information and stores the processed information in memory (e.g., a frame buffer), the display unit 112 can display the information stored in the frame buffer. More particularly, the display unit 112 can display various data according to data communication. For example, a user may want to generate an image through photographing and transmit the image to the second electronic device. Here, the display unit 112 can display the image and also can display a data value for the image. Furthermore, the display unit 112 can display a touch region in which a user input can be performed. Various screens output through the display unit 112 are described below with reference to screen diagrams.

The display unit 112 may become the display unit of the second electronic device. Here, the display unit of the second electronic device can display an app directory that is received from the first electronic device. The app directory is related to an app that is being executed in the first electronic device, and the app directory may be an element that includes at least one file related to an app. For example, if an app is a gallery app, the app directory may be an element for storing photo files related to the gallery app.

The touch panel 114 may be configured using a capacitive overlay method, a resistive overlay method, or an infrared beam method. The touch panel 114 generates a touch event in response to a user's gesture for a screen, performs Analog to Digital (AD) conversion on the touch event, and transfers the conversion results to the control unit 100. Here, the touch event includes one or more touch coordinates (x, y). For example, the touch Integrated Circuit (IC) of the touch panel 114 can detect a user's touch and determine a touch region in response to the touch. The touch IC can transfer touch coordinates (x, y) included in the touch region to the control unit 100. More particularly, the touch panel 114 can detect a user input according to data communication under the control of the control unit 100.

The communication unit 120 can perform a voice call, video telephony, or data communication with an external device over a network under the control of the control unit 100. The communication unit 120 may include a Radio Frequency (RF) transmitter for performing up-conversion and amplification on the frequency of a transmitted signal and an RF receiver for performing low-noise amplification and down-conversion a received signal. Furthermore, the communication unit 120 may include a mobile communication module (e.g., a 3^{rd} generation mobile communication module, a 3.5-generation mobile communication module, or a 4-generation mobile communication module), a digital broadcasting module (e.g., a Digital Multimedia Broadcasting (DMB) module), and short-distance communication modules (e.g., a Wireless Fidelity (Wi-Fi) module, a Bluetooth module, and a NFC module). The communication unit 120 may be configured to further include a Universal Serial Bus (USB). More particularly, the communication unit 120 can support a connection for data communication between the first electronic device and the second electronic device. The connection can be performed through a USB, Wi-Fi, Bluetooth, or NFC. USB is a port standard in which electronic devices for data communication are connected by putting a plug. Wi-Fi is technology that refers to a short-distance communication network over which the wireless Internet can be performed within a specific distance using electric waves or an infrared transmission method at the place where an Access Point (AP) is installed. Bluetooth is a short-distance networking technology standard on which various digital products are wirelessly connected without a wired access device. NFC is one of RFID techniques and is a contactless communication technique using a frequency band of 13.56 MHz.

The communication unit 120 may become the communication unit of the second electronic device. Here, the communication unit of the second electronic device can perform a connection for data communication with the first electronic device. The connection may be performed through a USB, Wi-Fi, Bluetooth, NFC, and the like.

The memory unit 130 stores a booting program, an operating system, and applications. More particularly, the memory unit 130 can store control data according to the directory detection module 102. The control data refers to data that selects operation mode or attachment mode in a program and derives a sequential flow or directly influences software operation. The control data may be a name, a size, a location an extension, a data value, and the like. More particularly, an app stores one or more data. Furthermore, an app may be configured to include data that can be stored. Here, the data that can be stored may be first data according to the driving of the app. The first data may be considered as an essential element (e.g., an application) according to the driving of the app. The data that can be stored may be second data that can be stored according to a user's intention. The second data may be considered as data that is generated according to a user's intention, such as photos or videos. Here, the memory unit 130 can store control data for distinguishing the first data and the second data according to the directory detection module 102 from each other.

The directory detection module 102 may use the control data for distinguishing the first data and the second data from each other. The control data can be determined by a name, a size, a location, an extension, a data value, and the like. For example, assuming that a user requests a photo of a gallery app to be transmitted to the second electronic device, the control unit 100 can detect an input for activating the gallery app and execute the gallery app. Here, the control unit 100 can operate the directory detection module 102 in conjunction with the gallery app. In such a case, the control unit 100 can detect a directory by distinguishing first data according to the driving of the gallery app from second data for storage through the directory detection module 102. The detection of the directory may be considered as the detection of the second data (e.g., a photo) stored in the gallery app. Furthermore, the detection of the directory may be a set of the second data (e.g., folders that classify family photos or scene photos) stored in the gallery app.

The control unit 100 performs functions for controlling the overall operation of the first electronic device and a flow of signals between the internal elements of the first electronic device and for processing data and controls the supply of power from a battery to the elements. More particularly, the control unit 100 can detect a connection for data communication with the second electronic device. Furthermore, the control unit 100 can detect an input for executing an app and execute the app. When the app is executed, the control unit 100 can execute the directory detection module 102. Here, the directory detection module 102 may be executed by default or in response to a user's input. For example, the directory detection module 102 may be a program executed by default, such as a PC explorer. In contrast, the directory detection module 102 can provide a key input or a touch input so that a program is driven in response to a user's input.

The control unit 100 can detect a directory for the app through the directory detection module 102. Furthermore, the control unit 100 can detect data, such as a file included in a folder within an app directory. Furthermore, the control unit 100 can transmit the detected app directory or the detected data, included in the folder within the app directory, to the second electronic device. Here, the control unit 100 may transmit the folder itself included in the app directory or may transmit folder information according to the design. The folder itself may include files stored in the folder. The folder information may be indication information indicating that a corresponding folder has what name and the corresponding folder is displayed in what type in the first electronic device or indication information about files within a corresponding folder. For example, the folder information may be icon information or thumbnail information that is indicated when a file is displayed on the first electronic device.

The control unit 100 may become the control unit of the second electronic device. In such a case, the control unit of the second electronic device can detect a connection for data communication with the first electronic device. Furthermore, the control unit of the second electronic device can receive information about an app directory from the first electronic device through the communication unit. Furthermore, the control unit can display the received app directory on the display unit.

The directory detection module 102 is a processor for identifying and detecting a directory and a detection module for identifying storage and an application. Furthermore, the directory detection module 102 is a detection module for rapidly detecting the directory of an app according to the execution of the app not the entire storage of the first electronic device. The directory is a region that includes a list of files stored in a disk, and the name, size, location, and the like, of each file are recorded in the directory.

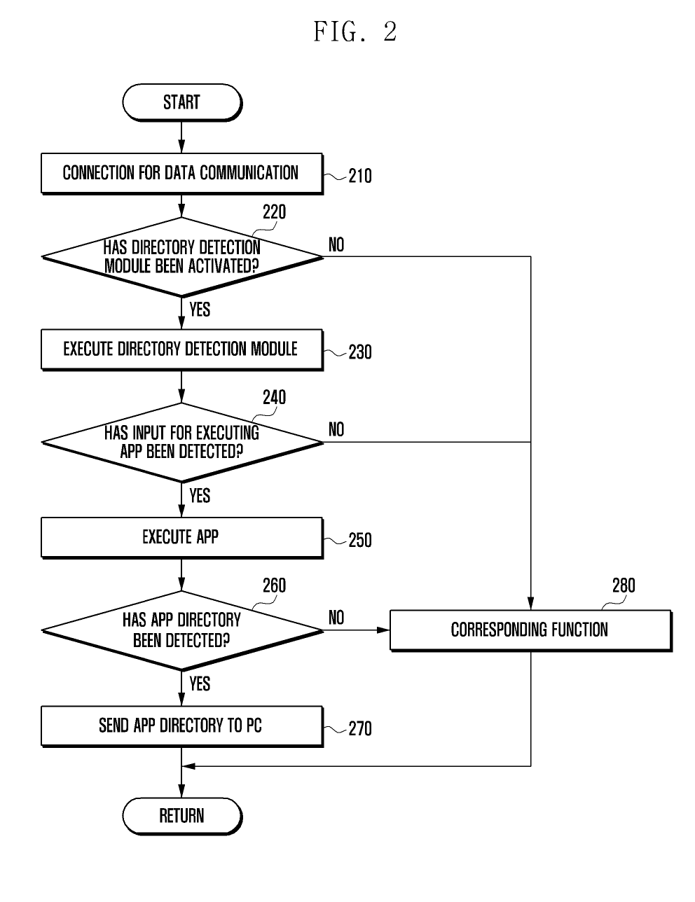

FIG. 2 is a flowchart illustrating a detection of a directory for execution of an app when a first electronic device and a second electronic device are connected according to an embodiment of the present disclosure. Referring to FIG. 2, the control unit 100 is assumed to be the control unit of the first electronic device.

Referring to FIG. 2, the control unit 100 can detect a connection with the second electronic device at operation 210. Here, the connection can be performed through a USB, Wi-Fi, Bluetooth, NFC, and the like.

When the first electronic device and the second electronic device are connected, the control unit 100 can detect a user input for activating the directory detection module 102 at operation 220. Here, the user input may be a key input or a touch input. When the user input is detected, the control unit 100 can execute the directory detection module 102 at operation 230.

When the directory detection module 102 is executed, the control unit 100 can detect a user input for executing an app at operation 240. Furthermore, the control unit 100 can execute the app at operation 250 and display the app on the display unit 112.

When the app is executed, the control unit 100 can detect a directory related to the app at operation 260. Here, the control unit 100 can detect the directory related to the execution of the app through the directory detection module 102. The directory detection module 102 may be driven in relation to control data stored in the memory unit 130 under the control of the control unit 100. The control data may be determined by a name, a size, a location, an extension, a data value, and the like. The control data may be used to identify storage and an application according to the detection of a directory. Furthermore, the control data may be used to detect the directory of an app according to the execution of the app not the entire storage of the first electronic device.

When the directory related to the app is checked, the control unit 100 can transmit the directory or directory-related information related to the directory to the second electronic device through USB, Wi-Fi, Bluetooth, or NFC at operation 270. Here, the directory may include a folder and files included in the folder. The directory-related information may be indication information that indicates a folder and files within the directory. The transmission may be performed in accordance with a Media Transfer Protocol (MTP). The MTP is a protocol for data communication between electronic devices. In accordance with the MTP, data can be transmitted through a specific unit, size, or boundary.

The control unit 100 can operate a PC explorer at operation 280 if the directory detection module 102 is not used at operation 220. The PC explorer is a window for displaying files or folders and may be considered as a basic utility. Furthermore, if a directory related to execution of the app is not detected at operation 260, the control unit 100 may return to operation 280.

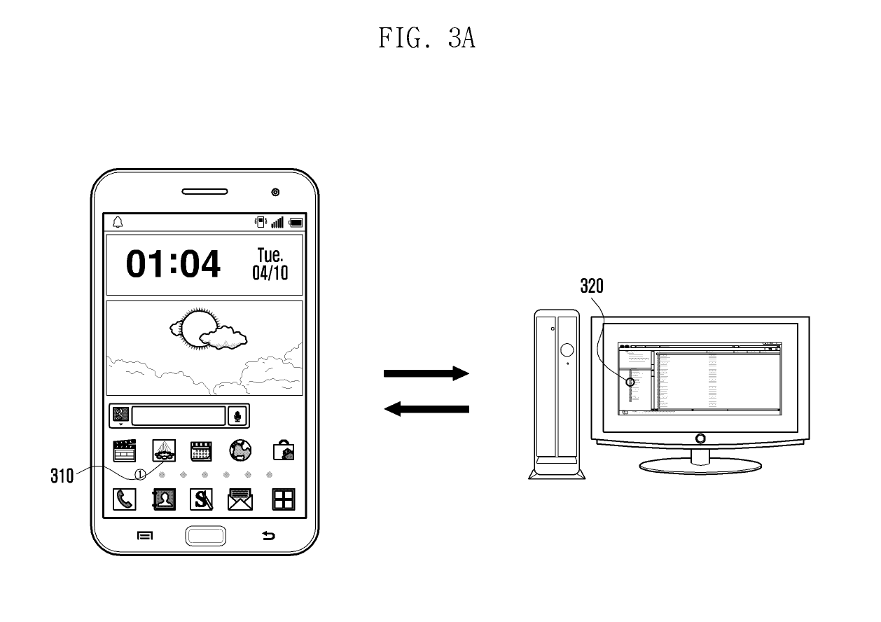

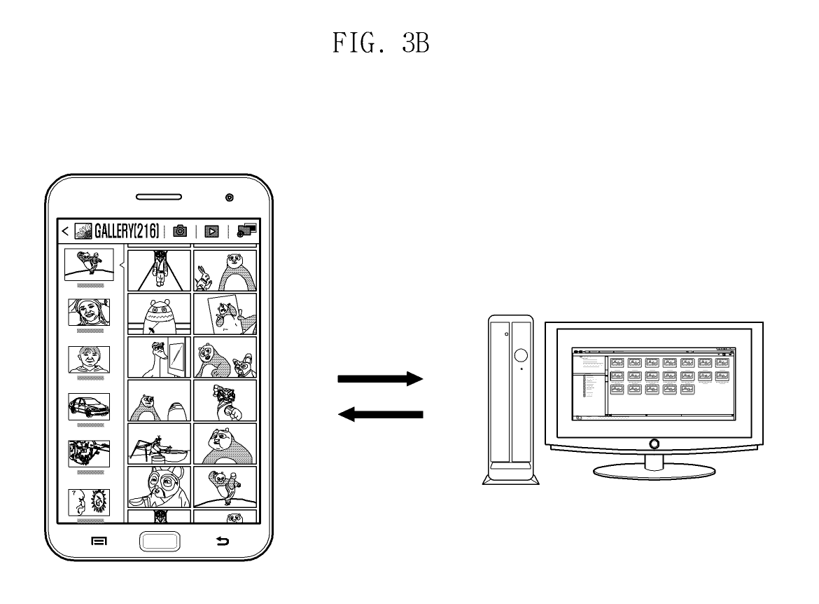

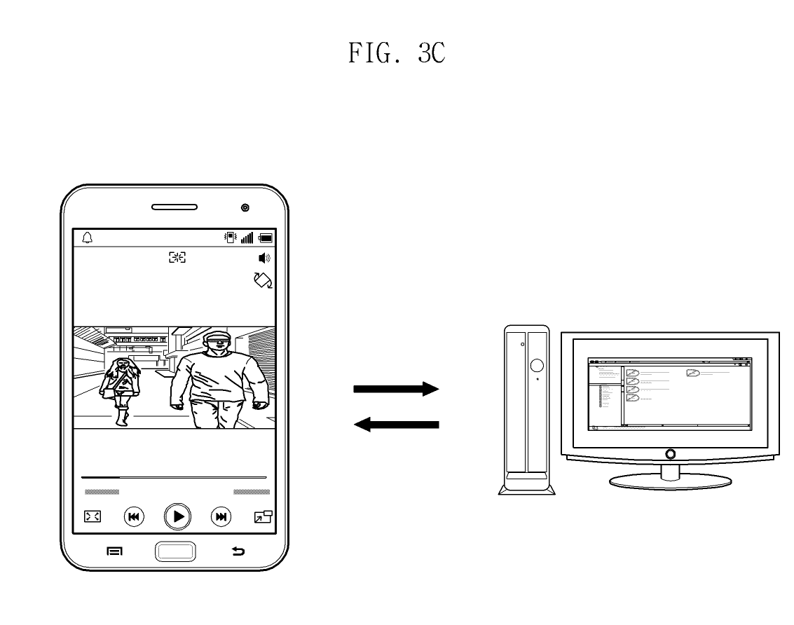

FIGS. 3A, 3B, and 3C illustrate a detection of a directory for execution of an app when a first electronic device and a second electronic device are connected according to an embodiment of the present disclosure.

Referring to FIG. 3A, the first electronic device and the second electronic device can perform a connection for data communication. Here, at least one of the two electronic devices can provide an input button for the directory detection module 102, such as an element 310 or an element 320. The input button is provided to suggest a specific example, such as the element 310 or the element 320, and the present disclosure is not limited thereto. When the element 310 of the first electronic device or the element 320 of the second electronic device is selected, the first electronic device can activate the directory detection module 102 and detect a directory related to an app that is being executed. For example, the first electronic device can check apps that are executed by a plurality of icons included in a standby screen and detect directories related to the respective apps. Accordingly, the first electronic device can transmit pieces of directory information related to a plurality of apps to the second electronic device.

When the pieces of directory information related to the standby screen are received from the first electronic device, the second electronic device can output the pieces of directory information to the display unit so that the pieces of directory information can be checked. Here, the second electronic device can classify and display the pieces of directory information according to icons or functions related to the respective icons. During this process, the second electronic device can display a list of functions corresponding to a plurality of icons and also output directory information related to a specific icon to the display unit. If a user selects another icon in a list of icons in the second electronic device, the second electronic device can control directory information related to the selected icon so that the directory information is displayed in a region where directory information is displayed.

Referring to FIG. 3B, after the first electronic device and the second electronic device are connected, the control unit 100 can receive an input for activating a specific app, for example, a gallery app. In response to the input, the control unit 100 can control the gallery app and control an operation for outputting a screen according to the execution of the gallery app to the display unit of the first electronic device. Furthermore, the control unit 100 can execute the directory detection module 102 in order to collect pieces of directory information to be transmitted to the second electronic device. When the directory detection module 102 is executed, the directory detection module 102 detects a directory related to the gallery app. The detection of a directory may include transmitting information about a directory corresponding to a point of time at which a user input was performed by incorporating the point of time into the information or information about data included in a folder within the directory to the second electronic device.

For example, in a process of initially activating the gallery app, the first electronic device may transmit information about one or more folders related to the gallery app and information related to files stored in each of the folders to the second electronic device. In response thereto, the second electronic device can configure a screen based on the information about the plurality of folders and display the configured screen. Here, the screen displayed on the display unit of the second electronic device may include pieces of information about the folders related to the gallery app. The second electronic device may display information about files included in a folder selected by default, that belong to the plurality of folders, in a specific region as shown in FIG. 3B. Accordingly, the second electronic device can output a thumbnail, corresponding to one or more photo files included in a specific folder, to a specific region. If another folder is selected in the second electronic device, a thumbnail included in the corresponding folder may be displayed in a specific region.

Referring to FIG. 3C, when a user requests the first electronic device to play back a video in the state in which the first electronic device and the second electronic device have been connected, the first electronic device can perform the playback of the video. While playing back the video, the first electronic device may transmit directory information related to a video playback function, for example, indication information about other videos to the second electronic device. If a plurality of folders related to the video playback function is included in a directory, the second electronic device can display a list including the folders on one side of a screen and display indication information about video files included in a selected and specific folder in a specific region. The directory for videos may be a set of folders (e.g., a movie folder or a learning folder) in which videos are stored. Furthermore, the directory for videos may be a folder if the folders are not present.

When a directory is detected through the directory detection module 102, the first electronic device may transmit data requested by a user to the second electronic device. The transmitted data may be displayed in a directory form through the second electronic device. For example, the directory form may be displayed by enlarging an image itself For example, the directory form may be displayed as a folder (e.g., a set of images). For example, the directory form may be displayed as each folder (e.g., a movie folder or a learning folder).

If a user requests another video other than a video, being executed in the first electronic device, to be executed in the second electronic device, the second electronic device can transmit a signal that requests the playback of another video to the first electronic device. When the signal that requests the playback of another video is received from the second electronic device, the first electronic device may stop the playback of the video that is being executed in the first electronic device and control an operation for playing back another video according to the playback request. Alternatively, the first electronic device may control an operation for playing back a plurality of video screens by controlling the screen of the video that is being executed.

FIGS. 3A, 3B, and 3C have been illustrated by taking a portable terminal and a PC as examples, but the present disclosure is not limited thereto. For example, the first electronic device may become a portable terminal, and the second electronic device may also become a portable terminal In other words, the first electronic device or the second electronic device is an electronic device for data communication and is not limited to the illustrated drawings.

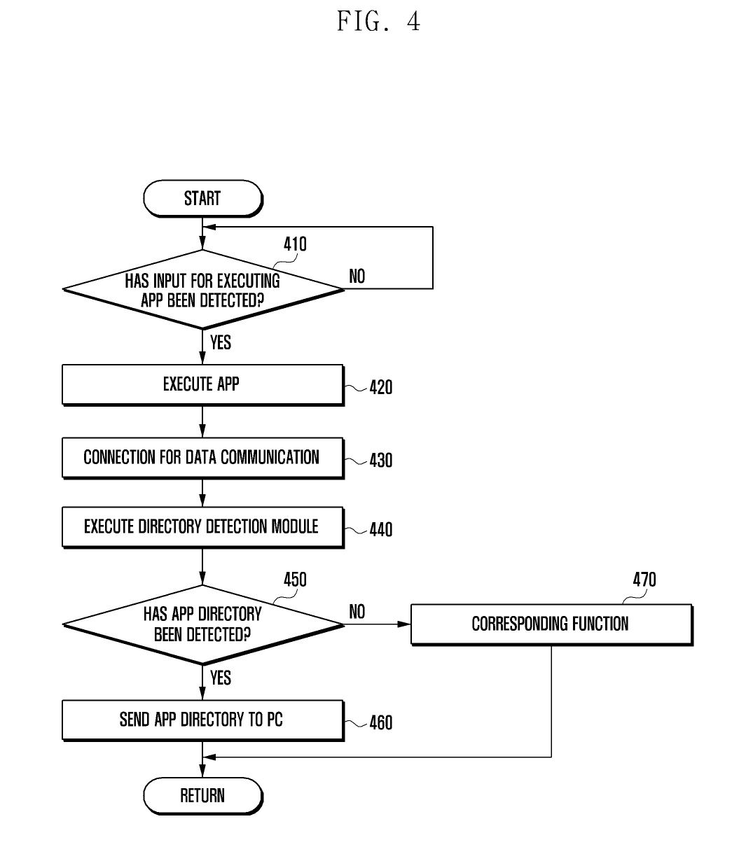

FIG. 4 is a flowchart illustrating a detection of a directory according to a connection between a second electronic device and a first electronic device while the first electronic device executes an app according to an embodiment of the present disclosure.

Referring to FIG. 4, the control unit 100 can detect an input for executing an app at operation 410. When the input for executing the app is detected, the control unit 100 can execute the app at operation 420.

When the app is executed, the control unit 100 can detect a connection for data communication between the first electronic device and the second electronic device at operation 430. Here, the connection may be performed through a USB, Wi-Fi, Bluetooth, NFC, and the like.

When the connection for data communication between the first electronic device and the second electronic device is performed, the control unit 100 can execute the directory detection module 102 at operation 440. When the directory detection module 102 is executed, a directory for the app can be detected under the control of the control unit 100 at operation 450. The directory for the app can be detected based on control data. The control data may be a name, a size, a location, an extension, a data value, and the like. The control data may be used to identify storage and an application according to the detection of a directory. Furthermore, the control data may be used to detect the directory for the app according to the execution of the app not the entire storage of the first electronic device.

When the directory for the app is detected, the control unit 100 may transmit the app directory to the second electronic device at operation 460. The transmission may be performed in accordance with the MTP.

When a directory according to the execution of the app is not detected, the control unit 100 returns to operation 470.

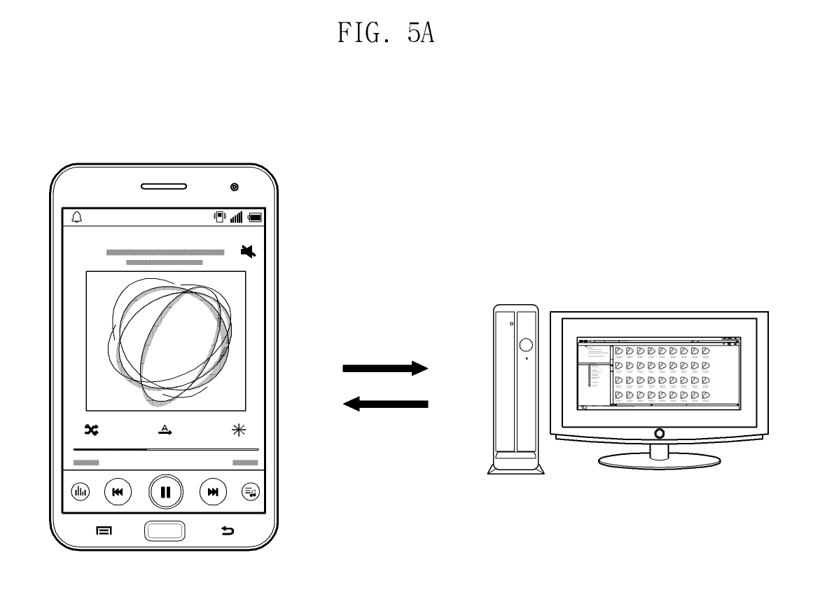

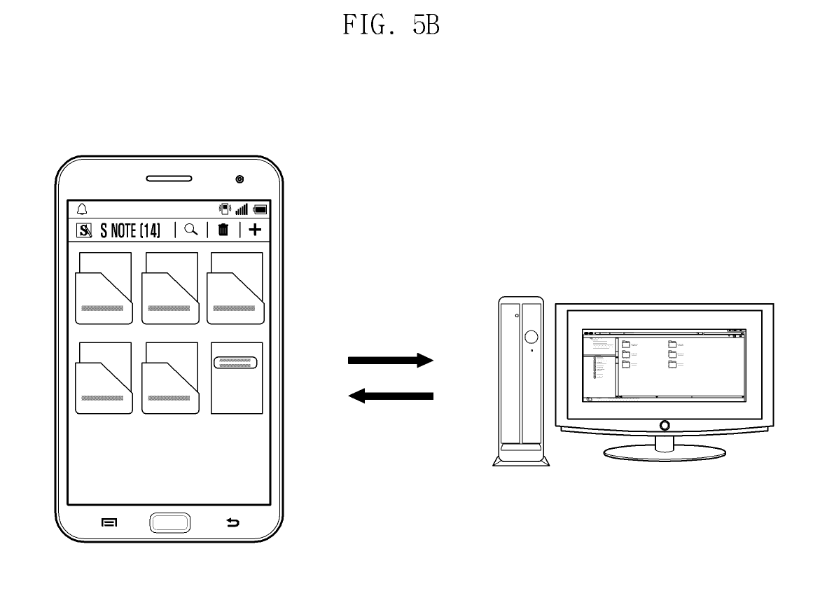

FIGS. 5A and 5B illustrate a detection of a directory according to execution of an app when a second electronic device is connected to a first electronic device while the first electronic device executes an app according to an embodiment of the present disclosure.

Referring to FIGS. 5A and 5B, a user may perform an input for executing an MP3 player. In response to the input, the first electronic device can execute a music playback function as shown in FIG. 5A. Thereafter, the first electronic device and the second electronic device may be connected. The connection may be performed through a USB, Wi-Fi, Bluetooth, or NFC, but is not limited thereto. The control unit 100 can detect the connection for data communication between the first electronic device and the second electronic device.

When the first electronic device and the second electronic device are connected for data communication, the control unit 100 can execute the directory detection module 102 in order to automatically detect a directory for an app that is being executed in the first electronic device, that is, the music playback function. When the directory detection module 102 detects the directory for the music playback function, the control unit 100 may transmit the directory for the music playback function to the second electronic device. When the directory for the music playback function is received, the second electronic device can output the directory to the display unit. Here, a displayed screen may include information about folders that include a music file or music files related to the app that is being executed in the first electronic device.

When a user executes a memo or note function, for example, S-Note as shown in FIG. 5B, the control unit 100 can detect the user input to S-Note and execute S-Note. Here, when the first electronic device and the second electronic device are connected for data communication, the control unit 100 can detect a directory for S-Note. Here, the directory may be configured to include folders within the directory. The folders may include a plurality of folders for a case where images are fetched through photographing and processed, a case where images are produced using S-Note, or a case where images are images downloaded from web pages. Here, each of the folders may include one directory. Furthermore, if only one folder is present, the folder itself may become a directory. Each of the folders may include files or data collected in each case.

When the directory related to S-Note is detected, the detected directory can be transmitted to the second electronic device under the control of the control unit 100. The transmission may be performed in accordance with the MTP.

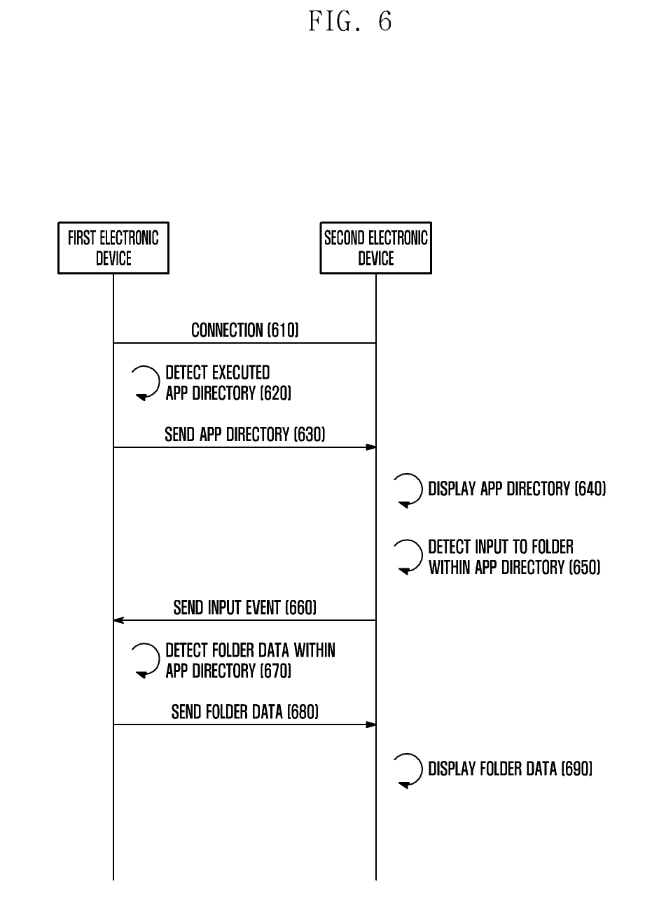

FIG. 6 is a flow diagram illustrating data communication between a first electronic device and a second electronic device according to an embodiment of the present disclosure.

Referring to FIG. 6, the first electronic device and the second electronic device may be connected for data communication at operation 610. The connection may be performed through a USB, Wi-Fi, Bluetooth, or NFC, but is not limited thereto.

When the first electronic device and the second electronic device are connected, the control unit 100 can detect an input for executing an app and execute the app.

When the app is executed in the first electronic device, the control unit 100 can detect a directory related to the executed app at operation 620. In order to detect the directory, the control unit 100 can execute the directory detection module 102. The directory can be detected based on control data. The control data may be a name, a size, a location, an extension, a data value, and the like. The control data may be used to identify storage and an application according to the detection of a directory. Furthermore, the control data may be used to detect the directory for the app according to the execution of the app not the entire storage of the first electronic device.

When the app directory is detected, the app directory can be transmitted to the second electronic device under the control of the control unit 100 at operation 630.

The second electronic device can display the received app directory on a screen of the second electronic device at operation 640. Furthermore, the second electronic device can detect a user input to a folder within the app directory at operation 650. Furthermore, the second electronic device can transmit the input event for the folder within the app directory to the first electronic device at operation 660.

The first electronic device can detect folder data within the app directory based on the received input event at operation 670. Furthermore, the first electronic device can transmit the detected folder data to the second electronic device at operation 680. The transmission may be performed in accordance with an MTP.

The second electronic device can display the received folder data within the app directory on a screen of the second electronic device at operation 690.

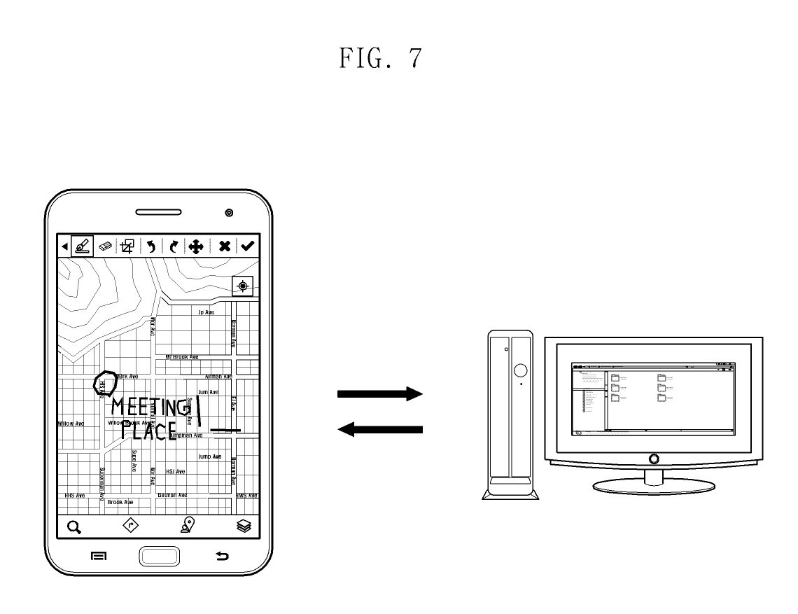

FIG. 7 illustrates a flow of signals for data communication between a first electronic device and a second electronic device according to an embodiment of the present disclosure.

Referring to FIG. 7, the first electronic device and the second electronic device are connected for data communication. Here, if a user input is generated in the first electronic device or the second electronic device, an event for the user input can be transmitted to the first electronic device or the second electronic device. For example, if a user wants to transmit an image including an appointed place, obtained by screen capturing in the first electronic device, to the second electronic device, corresponding data can be detected through the directory detection module 102 and transmitted to the second electronic device. Furthermore, the first electronic device can transmit information about a point of time at which the user input (e.g., a folder or an image) was performed by incorporating the point of time into the information through the directory detection module 102 to the second electronic device. Here, the transmission unit may be a USB, Wi-Fi, Bluetooth, or NFC. The transmission may be performed in accordance with the MTP.

The second electronic device can display the directory, received from the first electronic device, on a screen of the second electronic device. Here, the second electronic device can detect a user input to folder data within the directory received from the first electronic device. Furthermore, the second electronic device can detect the user input and transmit an event corresponding to the user input to the first electronic device. Here, the first electronic device can detect data included in a folder within an app directory in relation to the received input event. The first electronic device can transmit the detected data included in the folder within the app directory to the second electronic device. The folder data within the directory can be displayed on a screen of the second electronic device through the second electronic device.

If a user input to the folder within the app directory is performed in the first electronic device, the first electronic device can detect the user input to the folder within the directory and data within the folder through the directory detection module 102. Furthermore, the detected data can be transmitted to the second electronic device under the control of the control unit 100. The transmission may be performed in accordance with the MTP.

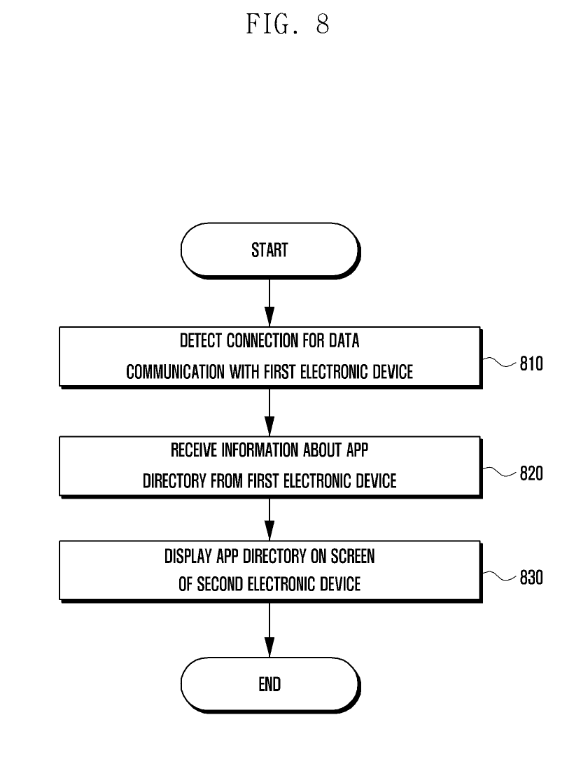

FIG. 8 is a flowchart illustrating data communication with a second electronic device according to an embodiment of the present disclosure.

Referring to FIG. 8, the second electronic device can detect a connection for data communication with the first electronic device at operation 810. The connection can be performed through a USB, Wi-Fi, Bluetooth, or NFC. Here, the second electronic device can receive information about an app directory from the first electronic device. For example, if a user wants to transmit a photo to the second electronic device through the first electronic device, the second electronic device can receive information about a corresponding app directory from the first electronic device at operation 820. Here, the first electronic device can detect the app directory through the directory detection module 102 and transmit the information about the app directory.

When the information about the app directory is received from the first electronic device, the second electronic device can display the app directory on a screen of the second electronic device at operation 830.

In the aforementioned description, the first electronic device has been illustrated as transmitting directory information related to an app that is being executed to the second electronic device, but the present disclosure is not limited thereto. For example, the first electronic device can perform a function of transmitting all pieces of directory information stored in the first electronic device to the second electronic device, and displaying directory information, related to an app that is being executed, on the display unit of the second electronic device. To this end, the first electronic device may transmit all the pieces of directory information to the second electronic device, but may transmit selection information, together with the pieces of directory information, to the second electronic device so that a directory related to an app that is being executed can be selected by default.

In a process of receiving directory information from the first electronic device and outputting the directory information, the second electronic device can check directory ID information related to an app that is being executed in the first electronic device and control an operation so that a directory corresponding to the directory ID information is selected. Accordingly, the second electronic device can select a directory related to an app that is being executed in the first electronic device by default in the state in which list information related to the directory has been output to one side of a screen and output information about folders included in the selected directory or information about files included in a folder to one side of a screen. Accordingly, a user can easily check a directory, related to an app that is being executed in the first electronic device, in the second electronic device without a need to perform an additional search process. Furthermore, when a user selects indication information about a specific file displayed on the second electronic device and requests the specific file to be activated, the activation request can be transmitted to the first electronic device. In response to the request, a screen of an app that is being executed in the first electronic device can be changed into a screen in which the file selected in the second electronic device is executed.

As described above, in accordance with the method and apparatus for operating a directory according to the present disclosure, a specific directory can be searched for, operated, and managed more intuitively.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for operating a directory, the method comprising:
detecting a directory related to a specific application or an app when a connection for data communication with a specific electronic device is detected; and
transmitting the detected directory or information about the detected directory to a second electronic device.

2. The method of claim 1, wherein the specific app comprises an app that is being executed.

3. The method of claim 1, further comprising performing the connection with the specific electronic device using at least one communication method of a Universal Serial Bus (USB), Wireless Fidelity (Wi-Fi), Bluetooth, and Near Field Communication (NFC).

4. The method of claim 1, wherein the detecting of the directory related to the specific app comprises detecting directory ID information indicative of a location where the directory related to the specific app is placed, of entire directory information of an electronic device.

5. The method of claim 4, wherein the transmitting of the detected directory or the information about the detected directory comprises transmitting the entire directory information and the directory ID information.

6. The method of claim 1, further comprising executing a directory detection module for detecting the directory related to the app.

7. The method of claim 1, wherein the detecting of the directory related to the specific app comprises identifying the directory related to the app based on control data that comprises at least one of a name, a size, a location, an extension, and a data value.

8. The method of claim 1, wherein the transmitting of the detected directory or the information comprises transmitting the directory or the information in accordance with a Media Transfer Protocol (MTP) method.

9. An electronic device comprising:
a communication unit configured to perform a connection for data communication with a specific electronic device; and
a control unit configured to detect a directory related to a specific application or an app when the connection for data communication with the specific electronic device is detected and to control an operation for transmitting the detected directory or directory indication information to the specific electronic device.

10. The electronic device of claim 9, wherein the communication unit supports at least one of a Universal Serial Bus (USB), Wireless Fidelity (Wi-Fi), Bluetooth, and Near Field Communication (NFC).

11. The electronic device of claim 9, further comprising a memory unit configured to store control data comprising at least one of a name, a size, a location, an extension, and a data value,
wherein the control unit identifies the directory related to the app based on the control data.

12. The electronic device of claim 9, wherein the control unit is further configured to control an operation for transmitting the directory or the directory indication information in accordance with a Media Transfer Protocol (MTP) method.

13. The electronic device of claim 9, wherein the control unit is further configured to detect directory ID information indicative of a location where the directory related to the specific app is placed, of entire directory information of the electronic device, and to control an operation for transmitting the entire directory information and the directory ID information.

14. A method for operating a directory, the method comprising:
detecting a connection for data communication with a specific electronic device;
receiving a directory related to a specific application or an app or information about the directory from the specific electronic device; and
displaying the received directory related to the specific app or the received information about the directory.

15. The method of claim 14, wherein the app comprises an app that is being executed in the specific electronic device.

16. The method of claim 14, wherein the receiving of the directory or the information about the directory comprises receiving the directory or the information in accordance with a Media Transfer Protocol (MTP) method.

17. The method of claim 14, wherein the receiving of the directory or the information about the directory comprises receiving directory ID information indicative of a location where the directory related to the specific app is placed, of entire directory information of an electronic device, along with the entire directory information.

18. An electronic device comprising:
a communication unit configured to perform a connection for data communication with a specific electronic device and to receive a directory related to a specific application or an app or information about the directory from the specific electronic device;
a display unit configured to display the received directory or the received information; and
a control unit configured to control the reception and control of the information.

19. The electronic device of claim 18, wherein the directory related to the specific app or the information about the directory is a directory related to an app that is being executed in the specific electronic device or information about the directory.

20. The electronic device of claim 18, wherein:
the communication unit is further configured to receive directory ID information indicative of a location where the directory related to the specific app is placed, of entire directory information of an electronic device, along with the entire directory information, and
the control unit is further configured to control an operation for outputting the directory related to the specific app, indicated by the directory ID information, to the display unit.
